(19) United States
(12) Patent Application Publication
(10) Pub. No.: US 2007/0076292 A1
(43) Pub. Date: Apr. 5, 2007

(54) Fully electric field shielding reticle pod

(75) Inventors: Wei-Yu Su, Banciao City (TW); Chuan-Chieh Lin, Hsinchu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 11/236,169

(22) Filed: Sep. 27, 2005

(51) Int. Cl. F21V 9/04; G02B 5/08; G02B 5/20; F21V 9/06

(52) U.S. Cl. 359/360

(57) ABSTRACT

A container includes a top wall, side walls, and a bottom wall, designed to enclose a space for storing an insulating object, the top, side and bottom walls having internal surfaces facing the enclosed space and external surface facing away from the enclosed space; and a metallic coating layer disposed on and substantially covering external surfaces of the top, side and bottom walls.

### BACKGROUND

When storing and transporting a reticle in a container, electronic-static charge (ESD) events may cause damage to the reticle carried therein. However, current reticle containers either could not effectively protect the reticle inside from ESD damage or is not cost effective.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIGS. 1, 2, and 3 illustrate cross-sectional views of various embodiments of a reticle container.

### DETAILED DESCRIPTION

It is to understood that the following disclosure provides many different embodiments, or examples, for implementing different features of various embodiments. Specific examples of components and arrangements are described simplistically for purposes of clarity. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A predecessor reticle container is described in U.S. Pat. No. 6,247,599 issued to Cheng, et al., entitled “ELECTROSTATIC DISCHARGE-FREE CONTAINER EQUIPPED WITH METAL SHIELD”, which is hereby incorporated by reference.

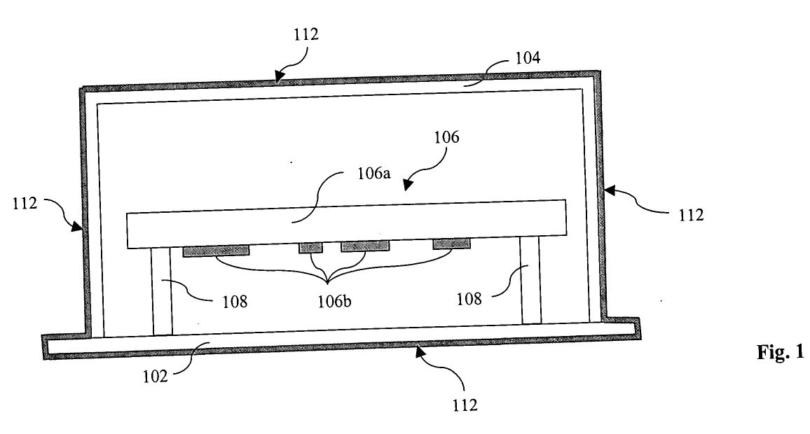

FIG. 1 is a cross-sectional view of an embodiment of a reticle container 100. Even though the reticle is employed as example to illustrate the disclosed structure, it is not limited to reticle container and may be extended to containers designed for carrying other ESD sensitive object(s). The reticle container 100 is designed to carry a reticle during storage and transportation. A reticle may also be referred to as photomask, or mask. The reticle container may also be referred to as reticle box, reticle pod, or a reticle carrier. The reticle container 100 may be alternatively designed to carry more than one reticle.

The reticle container 100 includes a bottom base 102 and a cover 104 positioned on the bottom base. The cover 104 has four side walls and a top lid. Both the bottom base 102 and the cover 104 are configured to define and enclose a space for storing an object such as a reticle 106. The bottom base 102 and the cover 104 may be two portions of a monolithic structure formed using a process such as molding. The bottom base 102 and the cover 104 may include a dissipative material (static dissipative material) or substantially made thereof. The electric dissipative material may include cellophane, glassine, and other suitable material that have a surface resistivity ranging between about 10⁵ ohms/square and 10¹² ohms/square. The bottom base 102 and the cover 104 may alternatively include plastic material or other suitable dielectric materials. In another embodiment, the bottom base 102 and the cover 104 may include a multilayer structure such as a layer of plastic film and a layer of static-dissipative material film combined and adhered to each other. The cover 104 is designed to include a door (not shown) in one of the side walls, operable to provide an opening for moving the reticle 106 into or out of the reticle container 100. The container 100 may be alternatively configured otherwise such as having a door formed and configured on the top lid or the bottom base. The cover 104 may further include a handle (not shown) formed on the top lid configured for human or automatic handling the reticle container 100. The reticle container 100 may include other suitable features as needed such as nozzles formed on the bottom base.

The reticle 106 includes a transparent substrate 106a having fused quartz (SiO₂), calcium fluoride (CaF₂), or other suitable material. The reticle 106 further includes a patterned absorption layer 106b formed using a plurality of materials such as chromium (Cr), iron oxide, or an inorganic film made with MoSi, ZrSiO, SiN, and/or TiN. The reticle may further include a plurality phase shifting features etched into or deposited onto the substrate, or integral with the absorption layer for phase shifting to a radiation beam passing through. In one example, the patterned absorption layer made of MoSi may also function as a phase shifter. The shifter may be incorporated into a phase-shift mask (PSM).

The reticle container 100 may further include a supporting member 108 configured to support the reticle 106 inside the container. The supporting member 108 may be integrated with the bottom base 102 and/or the cover 104 as a portion thereof.

The reticle container 100 further includes a metallic coating layer 112 disposed substantially on external surfaces of the bottom base 102 and the cover 104, such that to substantially cover both the bottom base 102, the cover 104, and the inside space for storing the reticle. Specifically, the metallic coating layer 112 substantially coats on the external surfaces of the bottom base 102, and external surfaces of the four side walls and the top lid of the cover 104. The metallic coating layer 112 may include stainless steel. The metallic coating layer 112 may alternatively include copper and/or other suitable metals such as aluminum, iron, and nickel, or combinations thereof. Alternatively, the external surface of the bottom base and the external surfaces of the cover may be coated with different type of metallic materials. The metallic coating layer 112 may have a thickness ranging between about 0.6 mm and about 1 mm. The metallic coating layer is formed using a method such as electroless plating, electroplating, chemical vapor deposition (CVD), physical vapor deposition (PVD) such as evaporation and sputtering, or a combination thereof. The reticle container 100 may further include an adhesive layer disposed between the metallic coating layer 112 and the external surfaces of the bottom base 102 and the cover 104 to enhance the adhesion therebetween.

Since the reticle includes substantially insulating material such as fused quartz substrate and is sensitive to electrostatic discharge (ESD) damage, the reticle container 100 thus designed provides a fully metal shielding protection of the reticle 106 from ESD damage with eliminated electric field leakage through penetration or induction. Furthermore, the disclosed structure provides a cost effective solution to mask workshops. With a metallic coating process, a onventional reticle container can be thus converted and reused with dramatically improved ESD protection.

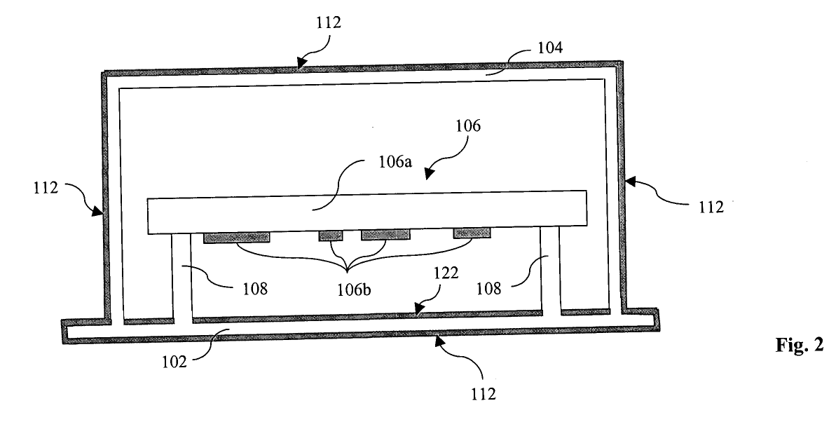

FIG. 2 is another embodiment of a reticle container 200 constructed according to aspects of the present disclosure. The reticle container 200 may be substantially similar to the reticle container 100 in terms of composition, configuration, and formation except for that the reticle container 200 has an additional metallic coating layer 122 disposed on internal surface of the bottom base 102 using similar material and process.

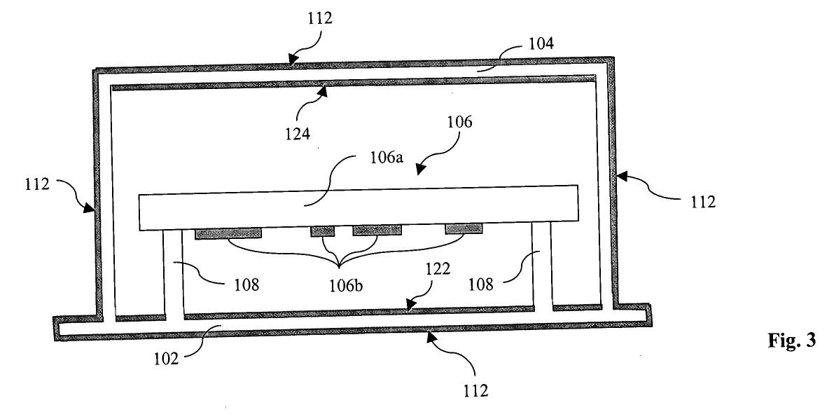

FIG. 3 is another embodiment of a reticle container 300 constructed according to aspects of the present disclosure. The reticle container 300 may be substantially similar to the reticle container 200 in terms of composition, configuration, and formation except for that the reticle container 300 has an additional metallic coating layer 124 disposed on internal surface of the top lid of the cover 102 using similar material and process. Alternatively, the metallic coating layer 124 may be extended to cover all internal surfaces of the four side walls such that a fully metallic liner is formed and a double-layer metallic structure is configured thereby to provide ESD protection to the reticle 106 stored inside of the reticle container 300.

Thus, the present disclosure provides a container. The container includes a top wall, side walls, and a bottom wall, designed to enclose a space for storing an insulating object, the top, side and bottom walls having internal surfaces facing the enclosed space and external surface facing away from the enclosed space; and a metallic coating layer disposed on and substantially covering external surfaces of the top, side and bottom walls.

The container may further include a first metallic liner disposed on internal surface of the bottom wall. The container may further include a second metallic liner disposed on internal surface of the top wall. In the container, the metallic coating layer may include stainless steel, copper, other suitable metal including aluminum, iron, and nickel, or a combination thereof. The metallic coating layer may have a thickness ranging between about 0.6 mm and 1 mm. The containing structure may include a dissipative material. The dissipative material may be selected from the group consisting of cellophane and glassine. The metallic coating layer may be formed by implementing a method selected from the group consisting of chemical vapor deposition, electro-less plating, electroplating, physical vapor deposition, and combinations thereof. The container may further include a supporting member to support the insulating object. The supporting member may include an insulating material. The insulating object may include a reticle. The reticle may include a material selected from the group consisting of fused quartz and calcium fluoride.

The present disclosure also provides a reticle container. The container includes a bottom base having a dissipative material, substantially having an external surface coated with a first metallic material; and a cover including four side walls and a top lid, configured with the bottom base to enclose a space for an object, wherein the cover includes the dissipative material and has external surfaces substantially coated with a second metallic material. In the reticle container, each of the first and second metallic materials may be selected from the group consisting of stainless steel and copper. Each of the first and second metallic materials may be formed by implementing electroless plating, or other suitable technologies.

The present disclosure also provides a method to form a fully metal shielding reticle container. The method includes form a dissipative material container having a top lid, four side walls, and a bottom base, and having a supporting member for support a reticle; and coating the dissipative material container using a metallic material.

In the disclosed method, the coating may include coating the dissipative material container using a material selected from the group consisting of stainless steel and copper. The coating may include implementing a method selected from the group consisting of electroless plating, electroplating, chemical vapor deposition, and physical vapor deposition.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. Therefore, the claims should be interpreted in a broad manner, consistent with the present disclosure.

What is claimed is:

1. A container, comprising:
a top wall, side walls, and a bottom wall, designed to enclose a space for storing an insulating object, the top, side and bottom walls having internal surfaces facing the enclosed space and external surface facing away from the enclosed space; and
a metallic coating layer disposed on and substantially covering external surfaces of the top, side and bottom walls.

2. The container of claim 1, further comprising a first metallic liner disposed on internal surfaces of the bottom wall.

3. The container of claim 1, further comprising a second metallic liner disposed on internal surfaces of the top wall.

4. The container of claim 1, wherein the metallic coating layer comprises stainless steel.

5. The container of claim 1, wherein the metallic coating layer comprises copper.

6. The container of claim 1, wherein the metallic coating layer comprises a material selected from the group consisting of aluminum, iron, nickel, and combinations thereof.

7. The container of claim 1, wherein the metallic coating layer comprises a thickness ranging between about 0.6 mm and about 1 mm.

8. The container of claim 1, wherein the containing structure comprises a dissipative material.

9. The container of claim 8, wherein the dissipative material is selected from the group consisting of cellophane and glassine.

10. The container of claim 1, wherein the metallic coating layer is formed by implementing a method selected from the group consisting of chemical vapor deposition, electro-less plating, electroplating, physical vapor deposition, and combinations thereof.

11. The container of claim 1, further comprising a supporting member to support the insulating object.

12. The container of claim 11, wherein the supporting member comprises an insulating material.

13. The container of claim 1, wherein the insulating object comprises a reticle.

14. The container of claim 13, wherein the reticle comprises a material selected from the group consisting of fused quartz and calcium fluoride.

15. A reticle container, comprising:
a bottom base having a dissipative material, substantially having an external surface coated with a first metallic material; and
a cover including four side walls and a top lid, configured with the bottom base to enclose a space for an object, wherein the cover includes the dissipative material and has external surfaces substantially coated with a second metallic material.

16. The container of claim 15, wherein each of the first and second metallic materials is selected from the group consisting of stainless steel and copper.

17. The container of claim 15, wherein each of the first and second metallic materials is formed by implementing electroless plating.

18. A method, comprising:
forming a dissipative material container having a top lid, four side walls, and a bottom base, and having a supporting member for support a reticle be enclosed in the container; and coating the dissipative material container using a metallic material.

19. The method of claim 18, wherein coating the dissipative material container comprises coating the container using a material selected from the group consisting of stainless steel and copper.

20. The method of claim 18, wherein coating the container comprises implementing a method selected from the group consisting of electroless plating, electroplating, chemical vapor deposition, and physical vapor deposition.
